(19) United States
(12) Patent Application Publication
(10) Pub. No.: US 2020/0188069 A1
(43) Pub. Date: Jun. 18, 2020

(54) Removably Adherable Cosmetic Teeth Covers

(71) Applicant: Betsy Lindbergh, Imperial, CA (US)

(72) Inventor: Betsy Lindbergh, Imperial, CA (US)

(21) Appl. No.: 16/717,808

(22) Filed: Dec. 17, 2019

Related U.S. Application Data
(60) Provisional application No. 62/780,649, filed on Dec. 17, 2018.

(51) Int. Cl. A61C 13/00; A61C 19/10

(52) U.S. Cl. CPC A61C 13/00; A61C 19/10

(57) ABSTRACT

A cosmetic tooth cover system includes one or a plurality of kits having a plurality of temporary tooth covers, each of which is configured to engage on and cover a viewable surface of a respective tooth in the mouth of a user. In a plurality of kits each may have a different color shade matchable to that of the teeth of the user, and each may have different sized sets of tooth covers to match the size of the user.

This application claims priority to U.S. Provisional Patent Application Ser. No. 62/780,649 filed on Dec. 17, 2018 which is incorporated herein in its entirety by this reference thereto.

### FIELD OF THE INVENTION

The disclosed device concerns teeth. More particularly, it relates to a device and method for the temporary adherence of thin covers upon the surface of teeth that are viewable when a user smiles.

### BACKGROUND OF THE INVENTION

In the field of cosmetic dentistry professional procedures for teeth appearance enhancement are widely available for the purpose of enhancing and improving the cosmetic appearance of teeth. Conventionally, such treatments are available from dental professionals and only at a dental office. These widely employed cosmetic treatments may include bleaching wherein a dentist will apply a professional grade whitener to the surface of the teeth. In some cases such whiteners may be light activated and once applied to the enamel surface a specialized light is communicated to the gel or whitening material on the teeth to activate it. This type of treatment may take one or more visits to a dentist.

For teeth which have physical issues such as dark spots or chips, or gaps and the like, bonding techniques may commonly be employed to adhere custom formed veneers to the viewable teeth in the mouth. This is a considerably more expensive procedure than simple bleaching and is intended to be permanent since bonding techniques employ a composite resin which is shaped and hardened, using special ultraviolet light or chemical processes during adherence to each tooth treated.

Another cosmetic procedure for less than attractive teeth employs a veneer covering for individual teeth. It involves the use of a custom made thin covering that matches the shape and color of the tooth. Such thin layer veneers may be employed to remove gaps or cover teeth that are discolored or lack an aesthetic shape. However, the attachment of such veneers are considered a substantially permanent process because small amounts of enamel from each tooth treated may be removed to accommodate the thickness the veneer.

As can be discerned, most such cosmetic treatments require appointments with a dental physician which can be expensive. Further, they may require the structural modification of each tooth treated to accommodate the coating or veneer layer engaged to the tooth, and such can lead to decay and other issues over time. Still further, such treatments are not generally available after normal business hours and without making advance appointments with a dental professional.

The device and method herein provide an easy-to-use system providing for temporary cosmetic or decorative coverings for individual teeth of a user, which allows for easy user employment. Using a plurality of provided thin coverings adapted for removable engagement with individual teeth, users can temporarily cosmetically enhance how teeth appear or can decorate their teeth for fun or a special occasion. The thin coverings are easily removable thereafter and no etching or structural changes in the enamel or the tooth are required.

The forgoing examples of cosmetic dentistry treatments and issues regarding such are intended to be illustrative and not exclusive, and they do not imply any limitations on the invention described and claimed herein. Various other limitations of the related art are known or will become apparent to those skilled in the art upon a reading and understanding of the specification below and the accompanying drawings.

### SUMMARY OF THE INVENTION

The device herein provides a user-employable system to temporarily improve the cosmetic appearance of one or a plurality of teeth in the mouth of a user. In some modes it may also be employed to decorate the visual portions of teeth in the mouth of a user such as with coloration, indicia, or other artwork which can be positioned on the thin layer coverings which are adapted for temporary positioning on tooth surfaces.

The device herein employed by the user includes thin preferably flexible individual tooth coverings which are provided in various sizes and shapes, as individual sized kits which adapted to fit a set of various sized and shaped teeth of a user.

In one preferred mode, the tooth coverings may be provided in peel and stick form from planar sheets of material having a plurality of individual coverings which may be removed from the sheet and operatively temporarily engaged upon one or a plurality of tooth surfaces. In another mode of the device the individual tooth coverings can be provided in a package of loose individual tooth coverings from which the user may choose individual coverings for removable adherence to chosen teeth for cosmetic or decorative enhancement.

In all modes of the device, a temporary adhesive is provided for the secure but temporary adherence of tooth coverings to the surface of each tooth chosen by the user. Such an adhesive may be pre-applied to the individual coverings, or may be provided in an applicator which the user employs to position the temporary adhesive to the individual tooth coverings during mounting to their teeth. Currently, the employment of a removable adhesive such as PROS-AID from ADM Tronics company, or a layer of micro-suction tape adhesive such as that from Sewell Direct, or a nontoxic crystal polymer or another removably engageable adhesive which is adapted for use in the mouth of a user.

The individual groupings of tooth coverings, whether sheet-based or provided loose in containers, are provided in kits which feature coverings of varying dimensions, and in various shades of white in each of the kits which are provided in groups as a sized kit configured for different sized user teeth. In use, the user measures the length and width of the largest sized incisor. Such a measurement may be accomplished with a ruler or tape, or as noted below using a phone app. From this length and width measurement, the user may discern which sized kit of tooth coverings will best fit the dimensions of their teeth. The user further will compare the color of their teeth to the multiple colors or shades of white that are provided with each kit of tooth coverings, and choose the shade or color they desire or that which most closely matches their own teeth. By color is meant herein, any color, shade of white, design, indicia, or other decorative or tooth matching color which may be imparted onto the viewed side of a tooth cover.

In a particularly preferred mode of the system herein, a phone application is provided which operates to employ an onboard camera of a smartphone in an examination of an incisor. Using a phone which is positioned a known distance from the incisor being examined, the camera will communicate a digital photo to software running on the phone to the task of determining a length and width of a tooth positioned in front of the camera lens. This may require holding the phone a specific distance from the tooth, or providing the user with a spacer to position between the phone and the tooth surface so a known distance can be determined. The phone application may also be configured to the task of examining the color of the tooth imaged by the camera and matching it to one of the provided colors of the tooth covers provided. Such allows the user to thereby ascertain the correct tooth cover size and color to choose.

Once the user has chosen the correct size of tooth covers having the desired color or shade, and chosen a kit of tooth covers either in sheet form or loose form, they may begin the process of engaging them to the teeth of choice. As noted above, the tooth covers may be provided with a removably engageable adhesive pre-applied, or the user may be provided with a dispenser to coat a contact surface of the cover with the removably engageable adhesive. The user then positions each tooth cover on the appropriate tooth, whereafter the removable adhesive will maintain it in place.

In another particularly preferred mode of the device, the individual tooth covers, whether provided in a kit upon a sheet of such covers, or in a container of loose individual covers, have a frangible positioning member extending from the tooth cover. This configuration provides for a much easier installation of each tooth cover since it may be held in proper alignment by holding the positioning member with one hand to align the tooth cover with the tooth, and thereafter using fingers from the other hand to press the tooth cover onto the tooth whereupon the adhesive will hold it removably engaged. The positioning member is rendered easily removable such as by forming a very thin or frangible line at the engagement point of the positioning member to the tooth covering, and as such, is removed once the cover is mounted.

As can be discerned, the system herein employed provides the device in the form of kits of tooth covers in a variety of size dimensions and shades of white, allow a user to quickly and easily temporarily adhere the appropriate chosen tooth covers to the teeth of choice, using the removably adherable adhesive also provided.

With respect to the above description, before explaining at least one preferred embodiment of the herein disclosed removably adherable cosmetic teeth cover invention in detail, it is to be understood that the invention is not limited in its application to the details of construction and to the arrangement of the components in the following description or illustrated in the drawings. The invention herein described and shown is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other thin layer removably adherable tooth covers and for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially” when employed herein, means plus or minus twenty percent unless otherwise designated in range.

It is an object of the present invention to provide an easily employable system for non professionals to temporarily cover viewable portions of teeth for cosmetic or decorative purposes.

These and other objects, features, and advantages of the present cosmetic and decorative tooth covering system, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed cosmetic and decorative tooth covering system and method. It is intended that the embodiments and figures disclosed herein are to be considered illustrative of the invention herein, rather than limiting in any fashion.

In the drawings:

FIG. 1 depicts a kit of removably adherable tooth covers which may be provided in varying dimensions of the tooth covers in the kit as well as in various shades or colors.

FIG. 2 shows the kit noted in FIG. 1 provided in one mode as a peel and stick sheet form where individual tooth covers formed to dimensions matching that discerned for a user and of a color or shade chosen by the user, may be removed and individually adhered to each respective tooth chosen by the user.

FIG. 3 depicts an example of teeth of a user for the device and method herein, prior to engagement of the appropriate sized kit of tooth covers and with the appropriate shade of tooth covers.

FIG. 4 shows the step of measuring the size of a tooth such as an incisor of choice for a length and width which will correlate to a sized kit of tooth covers of an appropriate size for use thereon to allow the user to choose the correct sized kit of tooth covers. Such may be with a software application on a smartphone and may also include a color determination by the same software once the chosen tooth is captured electronically in a photo.

FIG. 5 depicts a plurality of differently dimensioned tooth covers which may be provided which correlate to the determined teeth dimensions of the user as well as showing the kits of tooth covers may be provided in colors and shades chosen by the user.

FIG. 6 shows the two adjacent center incisors having been covered by removably engaged tooth covers which may be trimmed for size if necessary as shown in FIG. 7.

FIG. 7 shows the trimmer employed to trim the adhered covers at distal ends thereof, as desired by the user employing a trimmer.

FIG. 8 depicts the tooth covers removably engaged and trimmed to size by the user.

FIG. 9 shows a kit of tooth covers sized to a dimension associated with the length and width measurement of the teeth of a user similar to that of FIG. 2, wherein the tooth covers are individually positioned within a package in a kit.

FIG. 10 depicts the mounting surface of a typical tooth cover showing the removably adherable adhesive which may be pre positioned thereon or applied by the user from a dispenser.

FIG. 10A shows a sectional view of a tooth cover body depicting the tapering in thickness of the body of the tooth cover at the distal end thereof.

FIG. 11 depicts a tooth location illustration that may be provided to users which correlate teeth in a mouth to numbered tooth covers such as in FIG. 12, to help users ascertain the proper tooth in their mouth for engagement of the correlating cover.

FIG. 12 shows an especially preferred mode of the device herein wherein frangible positioners extend from each tooth cover which are adapted for gripping between the thumb and finger of the user. Such provides for easier and more accurate engagement on the face of each tooth to which they removably adhere, and which include indicia thereon correlating to the indicia associated with individual teeth in FIG. 11.

### DETAILED DESCRIPTION OF THE INVENTION

In this description, the directional prepositions of up, upwardly, down, downwardly, front, back, top, upper, bottom, lower, left, right and other such terms refer to the device as it is oriented and appears in the drawings and are used for convenience only and such are not intended to be limiting or to imply that the device has to be used or positioned in any particular orientation.

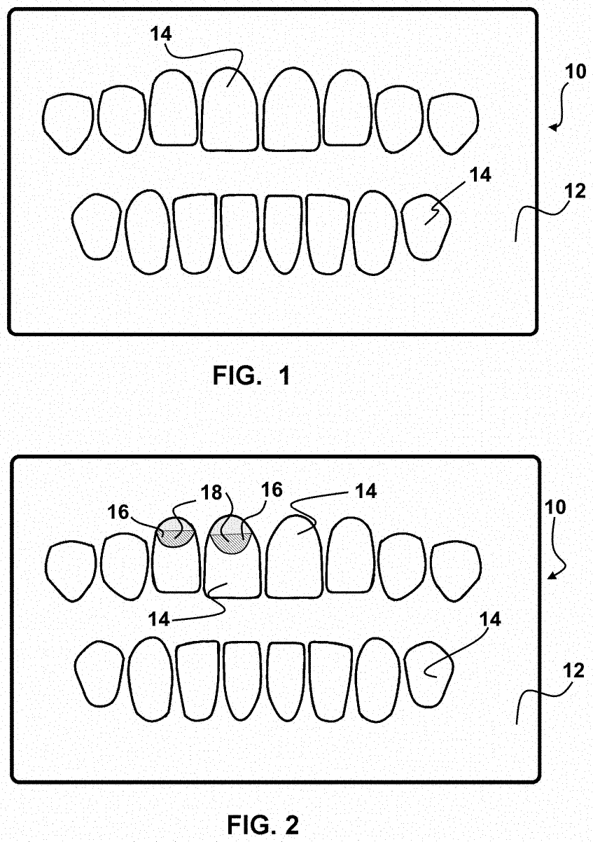

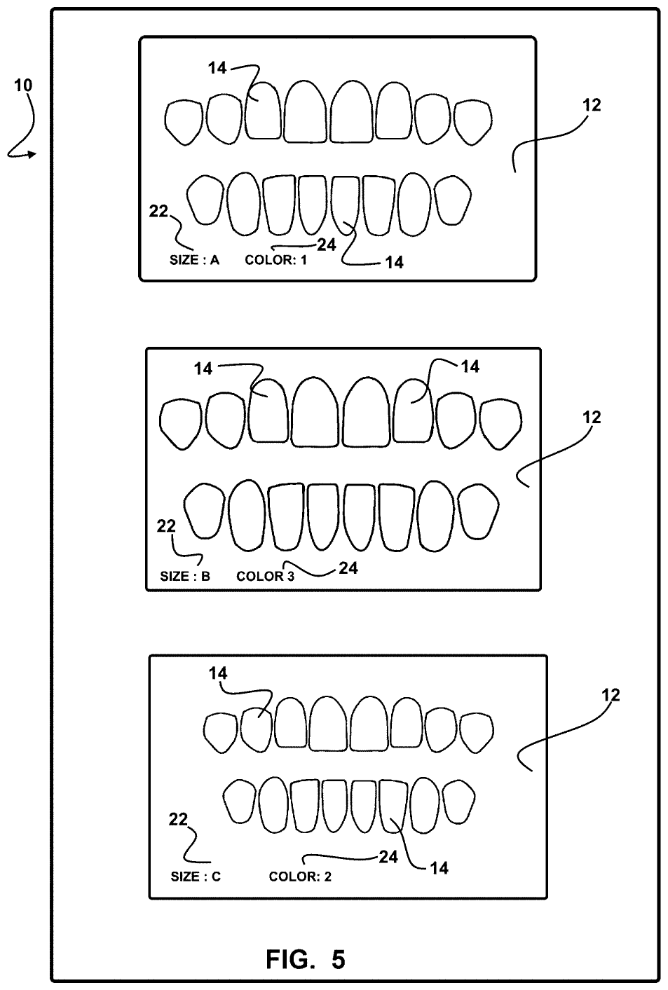

Now referring to drawings in FIGS. 1-12, wherein similar components are identified by like reference numerals, there is seen in FIG. 1 the device 10 herein which in all modes includes a kit 12 of removably adherable tooth covers 14. As noted and shown in FIG. 5, the tooth covers 14 in each kit 12 are provided as sized kit with dimensions which are predetermined to match the size of a group of teeth of a user, based on the width and length of the teeth of that user. Additionally noted herein, the color or shade of white of the displayed or second side of each tooth cover 14 in each kit 12 in the plurality of sized kits may vary, whereby multiple shades and colors are available to users in respective kits 12 of tooth covers 14 which are sized for each dimensional size.

In FIG. 2 is shown a mode of the kit 12 of tooth covers 14 wherein they are configured on a sheet and in a peel and stick sheet configuration for the plurality of tooth covers 14 in the kit 12. The contact side 16 of each tooth cover 14 may have the appropriate adhesive 18 pre-applied thereto, or as noted, the adhesive may be provided in a dispenser. This contact side 16, once adhered to an underlying tooth 20, positions the second side 16A opposite thereto, as viewable and forming a temporary cover over the underlying tooth 20.

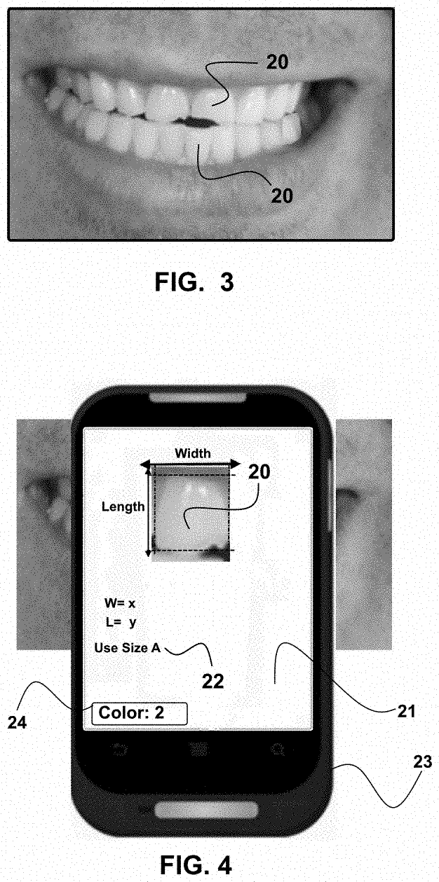

As an example of use for cosmetic purposes, in FIG. 3 is shown teeth 20 of a user where the tooth covers 14 herein may be applied for cosmetic reasons. In determining the appropriate size and shade or color of tooth covers 14 the user measures the length and width of an incisor with a tooth size determiner.

Such may be done with a ruler or a measuring tape, or, in a preferred mode of the system and device 10 herein shown in FIG. 4, the measuring or tooth size determiner may be accomplished with a smartphone or pad type computer 21 having a camera and a display 23. In this mode, sizing software running on the smartphone and operating to the task of calculating the length and width of a tooth captured by the digital camera, is employed to allow the user to discern the proper dimensioned kit 12 of tooth covers 14 to choose, having the size designator 22 for the tooth covers 14 which correlate to the tooth 20 size of the user, calculated by the software. The sizing software will depict the determined identifier size designator 22 of the proper dimensioned kit 12 on a display.

Additionally, color comparison software may also operate on the computing device 21 as a tooth color determiner, to use the captured tooth 20 image, to compare a color thereof to a database of tooth colors in electronic memory, and make a match therebetween to thereby discern and identify an appropriate color by color designator 24 or shade of white of the tooth 20, captured in the electronic photo. This color capture and comparison software may be employed to also inform the user on the display 23, of which of the plurality of designated colors 24 of covers 14 for which the kits 12 are available, correlates to the color discerned by the software running to that task. This will allow the user to choose a kit 12 of tooth covers 14 in the correct color 24 designator (FIG. 5) or shade or tint desired, based on the software matching the tooth 20 image to a color held in electronic memory correlating to a color 24 designator.

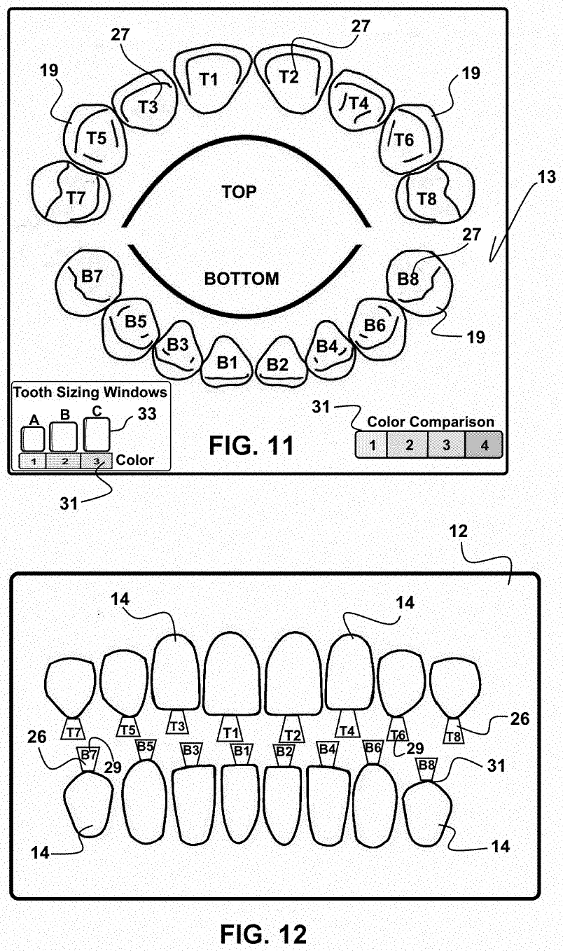

In an alternative tooth color determiner, and tooth size determiner, for the color measurement and tooth size measuring which is simpler, the user can be provided with a color comparison chart 31, and a plurality of different dimensioned sizing apertures 33 communicating through the planar body of the tooth cover 14 mounting location identifier 13, such as that of FIG. 11, or they may be formed on material holding the kit 12 of tooth covers 14. Such allows a user to hold the sizing apertures 33 in front of and surrounding a tooth 20, to determine a tooth size 22 designation, and to hold the color comparison chart 31 adjacent their tooth 20, to discern a match between a correlating color 24 designator on a kit 12 of covers 14, from the plurality of colors in the color comparison chart 31.

With this information the user may then choose a kit 12 of covers 14 having the matching tooth size 22 designator, and matching tooth color 24 designator, for the kit 12 of their tooth covers 14. The color comparison chart 31 was found in experimentation to work best for users to discern a kit 12 with the proper color 24 designator for the tooth covers 14, if located adjacent the sizing windows 33, as shown in FIG. 11. However, it will also work if the chart 31 is positioned adjacent an edge of the tooth cover 14 mounting location identifier 13. By adjacent is meant spaced between ⅛ to inch from an edge of the windows 33 or from a perimeter edge of the body of the tooth cover mounting location identifier 13.

As shown in FIG. 5, the system herein provides a plurality of kits 12 of tooth covers 14 in varying dimensions shown as size 22 designators. Additionally, for each kit 12 in each dimension or size 22 designator of individual tooth covers 14, a plurality of different shades, or color 24 designators are also made available. In this fashion, the user may choose the kit 12 having the plurality of tooth covers 14 correlating to the measured matching dimensions of their teeth 20, and may choose the kit 12 with the matching tint, shade or color 24 designator as desired.

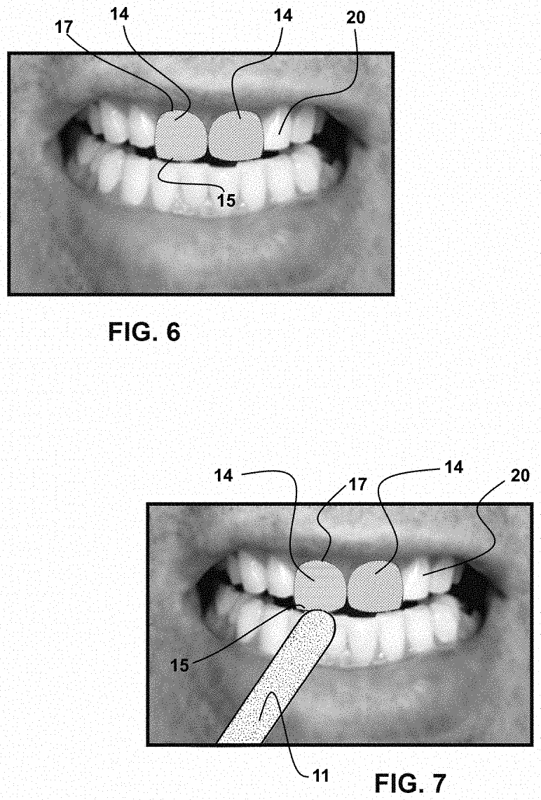

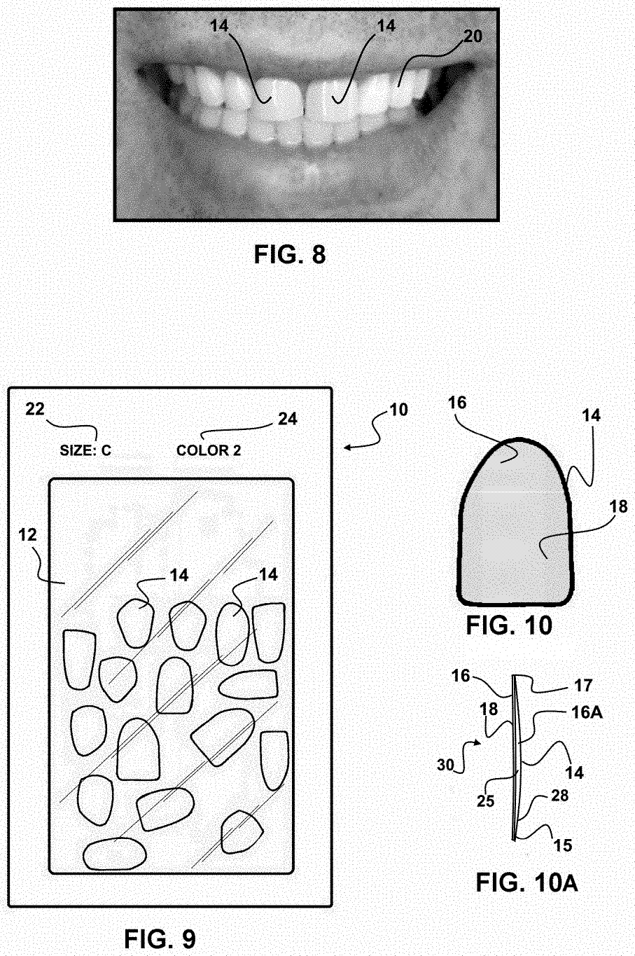

Once the user has chosen the correlating kit 12 in the appropriate size 22 designator of tooth covers 14, as shown in FIG. 6, the tooth covers 14 are then positioned and removably adhered to the teeth 20 of choice. As shown in FIG. 7, should trimming be desired to position the distal edge 15 of the tooth cover 14 in alignment with that of the underlying tooth 20, the material forming the tooth cover 14 is formed to be easily trimmed so as to form the tooth covers 14 to the proper dimensions as depicted in FIG. 8. While the tooth cover trimmer 11 that may be provided is shown as a flexible file such as an emery board, which has shown to work well and is preferred due to the safety provided to prevent cuts to the mouth, in other modes it may be an other trimming means adapted to the task such as a file, a blade, a small grinder, a knife, a scissor, a clipper, or another trimmer 11 adapted to the task.

Also of note to the device herein, the distal edges 15 of the tooth covers 14, which are adapted to trimming to size, are preferably tapered to a thinner cross section than a mid portion thereof between the first edge 17 and the distal edge 15 of the tooth cover 14. Such is shown for example in the sectional view of a tooth cover 14 body 30, shown in FIG. 10A.

This tapering is particularly preferred for a number of reasons. First, it renders the distal edge 15 easier to trim without cracking or damaging the tooth cover 14. Concurrently it forms a body of the tooth cover 14 in the mid portion between the distal edge 15 and first edge 17, which is sufficiently thick to hold together under the stresses of chewing and mouth movements.

Additionally, and equally as important, tapering the body of the tooth cover 14 to a thin cross section of material at the distal edge 15, positions a thinner portion of material forming the tooth cover body, adjacent the distal edge 15 of the tooth cover 14. Such, for example, is shown in FIG. 10A.

This configuration positioning a thin tooth cover 14 body portion at the distal end 15 thereby minimizes the force of food or the lower teeth 20 against the body of the tooth cover 14 against the distal edge 15, by instead defining a ramp. Minimizing the body of the tooth cover 14 thickness yielding the formation of such a ramp 28 on the tooth cover 14 engaged to the tooth 20, presents less side edge surface area at the distal edge 15, for contact against food and the like and renders the cover 14 less likely to disengage from the tooth.

Currently, a tapering thickness rendering the distal end 15 between 20-70 percent of the thickness of the mid portion 25 of the body of the tooth cover 14 between the first edge 17 and the distal edge 15, has been found to work well to accommodate both trimming once mounted, while also maintaining the integrity of the body of the tooth cover 14. While such depends on the polymeric or plastic material forming the cover 14, it is best to employ material allowing for the thinnest cross section at the distal end 15 from the noted range above to minimize the area for force and allow for easier trimming when necessary.

As noted herein and shown in FIG. 9, a kit 12 of tooth covers 14 sized to appropriate dimensions correlated to the measured length and width of the teeth of the user, can be provided as individual tooth covers 14 in a container such as blister pack or the like. As with other modes a plurality of kits 12 are provided with the tooth covers 14 in each kit 12 being of a size 22 and tint or color 24 appropriate to the choice of the user. As with other tooth covers 14 herein, they may include indica thereon or upon positioning members 26 extending therefrom, which correlates to the correct tooth for positioning thereof as in the illustration of FIG. 10.

As shown in FIG. 10, there is depicted a configuration typical of all tooth cover 14 of the kits 12 herein. As shown, the contact side 16, opposite the second side 16A of the body forming the tooth cover 14, has removably adherable adhesive 18 positioned thereon either in advance or through the user of an applicator of such by the user. Such allows the user to simply press the tooth cover 14 on the appropriate tooth for a removable engagement thereto of the contact side 16 leaving the second side 16A viewable and covering the underlying tooth 20 of the user to temporarily cosmetically enhance it.

As noted above, FIG. 11 depicts a tooth cover mounting location identifier 13, with individual respective tooth illustrations 19 correlating to a mouth location of teeth 20 of a user where that respective tooth 20 is located, which may be provided to users with the device 10 and system herein. Each depicted tooth illustration 19 on a first surface of the planar tooth location identifier 13 correlates to a mouth location of respective individual teeth 20 of a user.

Each depicted tooth illustration 19 depicted on the tooth cover mounting location identifier 13, correlates a mouth location of an actual individual respective top or bottom tooth 20 in the mouth of a user. Each depicted tooth illustration 19 is labeled with tooth location indicia 27 which correlates to or matches the tooth cover identification indica 29, which is located on each respective individual numbered tooth cover 14, or more preferably upon the respective positioning member 26 engaged with the correlating tooth cover 14, such as shown in FIG. 12. Experimentation has found that the provision of the tooth cover 14 mounting location identifier 13 with tooth location indicia 27 as a map of the locations of individual teeth 20 in the top and bottom arches of the mouth of users, provided significant help to users in ascertaining which of the tooth covers 14 was shaped, sized, and adapted best, for engagement with a respective identified tooth 20 in the mouth of the user, as shown on the first surface of the planar body of the tooth cover mounting location identifier 13 in the respective tooth illustrations 19.

Shown in FIG. 12 is an especially preferred mode of the device 10 of the system herein. As shown, each tooth cover 14 in the kit 12 also has a positioning member 26 extending from the distal end 15 of the body forming the tooth cover 14. The positioning member 26 allows the user to hold a tooth cover 14 in front of the correlating tooth, and visually align the tooth cover 14 with the underlying tooth 20 of choice more easily. Once so aligned holding the positioning member 26, the user may press the body of the tooth cover 14 onto the surface of the appropriate tooth 20 and the removably adherable adhesive 18 will hold it in operative position.

As noted, tooth cover identification indicia 29 on each tooth cover 14, or more preferably upon each positioning member 26, may correlate to the tooth identification indicia 29 on the first surface of the body of the tooth cover mounting location identifier 13 of FIG. 11. This is preferred as it provides the user with an easily discernable match of the proper tooth cover 14 to the correlating tooth 20 in the mouth of the user to which that tooth cover 14 is adapted to engage.

The positioning members 26 may be connected by adhesive adhering them to each tooth cover 14, and removed once the cover 14 is engaged. However, the positioning member 26 may also be formed as part of the tooth cover 14 in a unitary structure and formed with a removable engagement thereto. Such a removable engagement may be provided by forming a thin portion or perforated portion 35 or the like at the juncture of the positioning member 26 with the distal end 15 of the body of the tooth cover 14, thereby defining a disengagement point of the positioning member 26, with the distal end 15 of the body of each tooth cover 14. So formed, with a removable engagement using adhesive or using a separable engagement of a thin or perforated portion 35, such allows for easy removal of the positioning member 26 from the body of the tooth cover 14 once it is engaged to the correct tooth 20 in the mouth of the user. The positioning member 26 may be formed of transparent material to allow the user to see through it to the distal end 15 of the underlying tooth 20 located behind the positioning member 26, during positioning to an engagement on a tooth 20.

It should be noted that any of the different depicted and described configurations and components of the cosmetic and decorative tooth covering system herein, can be employed with any other configuration or component shown and described as part of the device herein. Additionally, while the present invention has been described herein with reference to particular embodiments thereof and/or steps in the method of production or use, a latitude of modifications, various changes and substitutions are intended in the foregoing disclosure, and it will be appreciated that in some instance some features, or configurations, of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A cosmetic tooth cover apparatus, comprising:
a kit having a plurality of individual tooth covers, said tooth covers having a body having a first edge opposite a distal edge and having a mid portion of said body therebetween;
each said tooth cover configured in a size and shape for a removable engagement to a mounting location on a respective tooth in a mouth of a user; and
each said tooth cover having a contact surface opposite a second surface;
each said contact surface configured for a removable engagement with adhesive thereon, to a said respective tooth, whereby a user can removably engage each of said tooth covers to a respective mounting location positioning said second surface of said body as a viewable covering surface thereon.

2. The cosmetic tooth cover apparatus, of claim 1, additionally comprising:
each said body of each said tooth cover tapering in thickness from a thicker portion of said body at said mid portion to a thinner portion of said body at said distal edge; and
said tapering in thickness defining a ramp on said second surface, said ramp extending from said distal end toward said mid portion of said body.

3. The cosmetic tooth cover apparatus, of claim 2, additionally comprising:
a trimmer, said trimmer engageable with said distal end of said body of each said tooth cover to trim said tooth cover.

4. The cosmetic tooth cover apparatus, of claim 1, additionally comprising:
a tooth cover mounting location identifier having a planar body and having mouth location tooth illustrations identified by location indicia positioned on a first side of a planar body; and
each of said tooth covers in said kit having tooth cover identification indicia correlating to a respective said location indica of said tooth illustrations, whereby a user can determine a respective tooth mouth location for each respective tooth cover from a matching of said tooth cover identification indicia.

5. The cosmetic tooth cover apparatus, of claim 2, additionally comprising:
a tooth cover mounting location identifier having a planar body and having mouth location tooth illustrations identified by location indicia positioned on a first side of a planar body; and
each of said tooth covers in said kit having tooth cover identification indicia correlating to a respective said location indica of said tooth illustrations, whereby a user can determine a respective tooth mouth location for each respective tooth cover from a matching of said tooth cover identification indicia.

6. The cosmetic tooth cover apparatus, of claim 3, additionally comprising:
a tooth cover mounting location identifier having a planar body and having mouth location tooth illustrations identified by location indicia positioned on a first side of a planar body; and
each of said tooth covers in said kit having tooth cover identification indicia correlating to a respective said location indica of said tooth illustrations, whereby a user can determine a respective tooth mouth location for each respective tooth cover from a matching of said tooth cover identification indicia.

7. The cosmetic tooth cover apparatus, of claim 4, additionally comprising:
a plurality of said kits, each of said kits having a plurality of said tooth covers adapted for engagement as a sized kit;
each said sized kit configured to cover a different sized group of teeth of a user;
a plurality of sizing apertures communicating through the body of said tooth cover mounting location identifier; and
one each of said plurality of apertures correlating to a respective sized kit of said tooth covers, whereby a user positioning one of said sizing apertures to surround a tooth viewable therethrough, can determine the correlating sized kit of said tooth covers to removably engage.

8. The cosmetic tooth cover apparatus, of claim 5, additionally comprising:
a plurality of said kits, each of said kits having a plurality of said tooth covers adapted for engagement as a sized kit;
each said sized kit configured to cover a different sized group of teeth of a user;
a plurality of sizing apertures communicating through the body of said tooth cover mounting location identifier; and
one each of said plurality of apertures correlating to a respective sized kit of said tooth covers, whereby a user positioning one of said sizing apertures to surround a tooth viewable therethrough, can determine the correlating sized kit of said tooth covers to removably engage.

9. The cosmetic tooth cover apparatus, of claim 6, additionally comprising:
a plurality of said kits, each of said kits having a plurality of said tooth covers adapted for engagement as a sized kit;
each said sized kit configured to cover a different sized group of teeth of a user;
a plurality of sizing apertures communicating through the body of said tooth cover mounting location identifier; and
one each of said plurality of apertures correlating to a respective sized kit of said tooth covers, whereby a user positioning one of said sizing apertures to surround a tooth viewable therethrough, can determine the correlating sized kit of said tooth covers to removably engage.

10. The cosmetic tooth cover apparatus, of claim 4, additionally comprising:
each of said plurality of said kits having said tooth covers thereof, formed in a respective different color from the others in said plurality of said kits;
a color comparison chart positioned on said planar body of said tooth cover mounting location identifier;
said color comparison chart having colorized sections thereon, each respective colorized section correlating to a respective color of one respective kit of said tooth covers, whereby a user can employ said color comparison chart to a color of a tooth, and choose a kit of tooth covers.

11. The cosmetic tooth cover apparatus, of claim 5, additionally comprising:
each of said plurality of said kits having said tooth covers thereof, formed in a respective different color from the others in said plurality of said kits;
a color comparison chart positioned on said planar body of said tooth cover mounting location identifier;
said color comparison chart having colorized sections thereon, each respective colorized section correlating to a respective color of one respective kit of said tooth covers, whereby a user can employ said color comparison chart to a color of a tooth, and choose a kit of tooth covers.

12. The cosmetic tooth cover apparatus, of claim 6, additionally comprising:
each of said plurality of said kits having said tooth covers thereof, formed in a respective different color from the others in said plurality of said kits;
a color comparison chart positioned on said planar body of said tooth cover mounting location identifier;
said color comparison chart having colorized sections thereon, each respective colorized section correlating to a respective color of one respective kit of said tooth covers, whereby a user can employ said color comparison chart to a color of a tooth, and choose a kit of tooth covers.

13. The cosmetic tooth cover apparatus, of claim 7, additionally comprising:
each of said plurality of said kits having said tooth covers thereof, formed in a respective different color from the others in said plurality of said kits;
a color comparison chart positioned on said planar body of said tooth cover mounting location identifier;
said color comparison chart having colorized sections thereon, each respective colorized section correlating to a respective color of one respective kit of said tooth covers, whereby a user can employ said color comparison chart to a color of a tooth, and choose a kit of tooth covers.

14. The cosmetic tooth cover apparatus, of claim 8, additionally comprising:
each of said plurality of said kits having said tooth covers thereof, formed in a respective different color from the others in said plurality of said kits;
a color comparison chart positioned on said planar body of said tooth cover mounting location identifier;
said color comparison chart having colorized sections thereon, each respective colorized section correlating to a respective color of one respective kit of said tooth covers, whereby a user can employ said color comparison chart to a color of a tooth, and choose a kit of tooth covers.

15. The cosmetic tooth cover apparatus, of claim 9, additionally comprising:
each of said plurality of said kits having said tooth covers thereof, formed in a respective different color from the others in said plurality of said kits;
a color comparison chart positioned on said planar body of said tooth cover mounting location identifier;
said color comparison chart having colorized sections thereon, each respective colorized section correlating to a respective color of one respective kit of said tooth covers, whereby a user can employ said color comparison chart to a color of a tooth, and choose a kit of tooth covers.

16. The cosmetic tooth cover apparatus, of claim 1, additionally comprising:
positioning members in a removable engagement with each said tooth cover, said positioning members extending from the distal end of each of said tooth covers in said kit.

17. The cosmetic tooth cover apparatus, of claim 2, additionally comprising:
positioning members in a removable engagement with each said tooth cover, said positioning members extending from the distal end of each of said tooth covers in said kit.

18. The cosmetic tooth cover apparatus, of claim 4, additionally comprising:
positioning members in a removable engagement with each said tooth cover, said positioning members extending from the distal end of each of said tooth covers in said kit; and
tooth cover identification indica correlating to a respective said tooth cover mounting location identifier, on each of said positioning members.

19. The cosmetic tooth cover apparatus, of claim 10, additionally comprising:
positioning members in a removable engagement with each said tooth cover, said positioning members extending from the distal end of each of said tooth covers in said kit; and
tooth cover identification indica correlating to a respective said tooth cover mounting location identifier, on each of said positioning members.

20. The cosmetic tooth cover apparatus, of claim 7, additionally comprising:
sizing software running on a computing device, said sizing software configured to calculate the correlating sized kit of said tooth covers for a user from a digital photo of said teeth of said user;
said sizing software depicting an identifier of said correlating sized kit on a display screen;
each of said plurality of said kits having said tooth covers thereof, formed in a respective different color from the others in said plurality of said kits;
color comparison software running on said computing device configured for the task of determining a matching color of a respective kit of said tooth covers which correlates to a color of said teeth in said digital photo; and
said color comparison software configured to depict an identifier of said matching color on said display screen.
